(19) United States
(12) Patent Application Publication
(10) Pub. No.: US 2014/0195360 A1
(43) Pub. Date: Jul. 10, 2014

(54) SALES SYSTEM AND METHOD, AND COMPUTER PROGRAM THEREOF

(71) Applicant: Toshiba Tec Kabushiki Kaisha, Tokyo (JP)

(72) Inventors: TAKAHIDE KUBOTA, Shizuoka-ken (JP); Takeshi SHIMAZAKI, Shizuoka-ken (JP); Masanori SAMBE, Shizuoka-ken (JP); Rintaro NAKANE, Kanagawa-ken (JP); Hajime TOMIZAWA, Shizuoka-ken (JP); Yun WANG, Kanagawa-ken (JP); Maki SATO, Kanagawa-ken (JP); Mahina NAKAMURA, Tokyo (JP)

(73) Assignee: Toshiba Tec Kabushiki Kaisha, Tokyo (JP)

(21) Appl. No.: 14/145,051

(22) Filed: Dec. 31, 2013

(30) Foreign Application Priority Data
Jan. 8, 2013 (JP) 2013-001307

(51) Int. Cl. G06Q 20/20

(52) U.S. Cl. CPC G06Q 20/204
USPC 705/17; 705/16

(57) ABSTRACT

A sales system includes a display unit and a selection unit configured to provide for display on the display unit a selection screen including at least one product image, and accept a user selection of one or more product images in the selection screen. The sales system further includes a control unit configured to calculate and provide for display on the display unit a total purchase price of products corresponding to the product images which are selected in the selection unit, and an accounting unit configured to settle payment for the total purchase price of the products.

### CROSS-REFERENCE TO RELATED APPLICATION

This application is based upon and claims the benefit of priority from Japanese Patent Application No. 2013-001307, filed Jan. 8, 2013; the entire contents of which are incorporated herein by reference.

### FIELD

Embodiments described herein relate generally to a sales system which includes a function for product sale processing, and a program thereof.

### BACKGROUND

A device which executes product sale processing while displaying guide information or sales promotion information for shoppers on a display unit on a top face of a counter-type cash register counter is known.

While an operation by a salesperson is performed, it is possible for a shopper who wants to purchase a product to wait for the operation of the salesperson while viewing the information displayed on the cash register counter.

A product sale processing device which is described above only performs sale processing of a product which is brought in by a shopper. There may be a case in which a shopper wants to get advice or the like from a salesperson at a stage before purchasing a product, depending on the shopper.

### DESCRIPTION OF THE DRAWINGS

FIG. 1 is a diagram which illustrates a configuration of a sales system according to one embodiment.

FIG. 2 is a block diagram which illustrates a control circuit of the embodiment.

FIG. 3 is a flowchart which describes a control of the embodiment.

FIG. 4 is a diagram which illustrates a selection screen which is displayed on a table according to the embodiment.

FIG. 5 is a diagram which illustrates an accounting screen which is displayed on an accounting terminal according to the embodiment.

FIG. 6 is a diagram which illustrates a guide screen which is displayed by being popped up on the accounting screen in FIG. 5.

### DETAILED DESCRIPTION

An object of the embodiments is to provide a sales system in which a shopper and a salesperson are able to perform a selection and a sale of a product while having an appropriate communication, and a program for performing related functions.

A sales system according to an embodiment includes a display unit and a selection unit configured to provide for display on the display unit a selection screen including at least one product image, and accept a user selection of one or more product images in the selection screen. The sales system further includes a control unit configured to calculate and provide for display on the display unit a total purchase price of products corresponding to the product images which are selected in the selection unit, and an accounting unit configured to settle payment for the total purchase price of the products.

Hereinafter, exemplary embodiments will be described with reference to drawings.

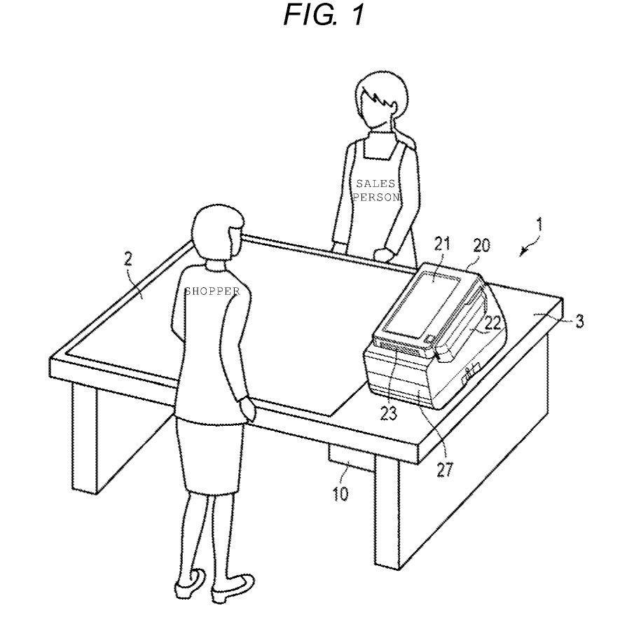

As illustrated in FIG. 1, a sales counter table 1, which serves as a reception table, is arranged in a store. A touch panel-type display unit 2 is arranged flush with a top face of the table 1. A controller 10 which controls the touch panel-type display unit 2 is arranged on the lower surface side of the table 1. The controller 10 may be mounted inside the table 1, accommodated in a drawer if there is a drawer in the table 1, or attached to a leg portion or a side plate of the table 1.

On the top face of the table 1, an accounting terminal 20 which may perform a card settlement as an accounting means is arranged in a region 3 near the touch panel-type display unit 2.

The accounting terminal 20 functions as a Point of Sales (POS) system in a store, and includes a touch panel-type display unit 21, a card reader 22, a printer 23, and a drawer 27. The card reader 22 reads out data which is recorded in a card, when a card for settling is presented by a customer (for example, a credit card, a debit card, or the like) and inserted or slid. The printer 23 prints accounting information on a rolled paper, which is discharged as a receipt. The drawer 27 accommodates cash which is handled when accounting using cash.

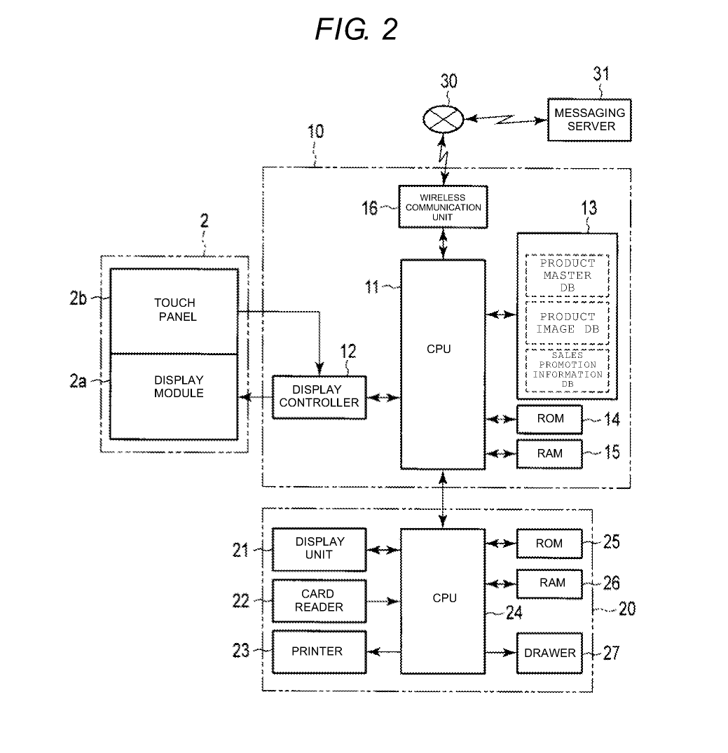

A control circuit of a reception system with such a configuration is illustrated in FIG. 2. The touch panel-type display unit 2 includes a display module 2a which may display a color image, and a full touch panel 2b which is arranged on the display module 2a. The touch panel-type display functions as a Graphical User Interface (GUI).

The controller 10 may be a microcomputer, and includes a CPU 11, a display controller 12, a hard disk drive (HDD) 13, a ROM 14, a RAM 15, and a wireless communication unit 16.

The display controller 12 displays various screens which are generated by the CPU 11 on the display module 2a. The display controller 12 supplies display contents in the display module 2a corresponding to a touch position when the full touch panel 2b is touched, to the CPU 11, as input information.

The hard disk drive 13 stores a product master database, which includes a product code, product price data, and the like and which is necessary for accounting in the accounting terminal 20. The hard disk drive 13 also stores a product image database which includes image data of various products for sale. The hard disk drive 13 also stores a sales promotion information database which includes image data or character data for sales promotion, or the like.

The ROM 14 stores programs and data such as: a program which is necessary for controlling the CPU 11, various application programs which are necessary for product sale processing using an image display of the touch panel-type display unit 2, character data or image data for generating various screens which are displayed on the touch panel-type display unit 2, coordinate data for designating display regions of the character data or image data, and image data which is read out from the product image database on the display module 2a.

The RAM 15 stores various data items. The wireless communication unit 16 transmits and receives data between the CPU 11 and a managing server 31 through a communication network which may be, for example, a Local Area Network (LAN) 30.

The managing server 31 communicates with the above described POS system, and appropriately updates the product master database in the hard disk drive 13, the product image database, the sales promotion information database, and the like, through data transfer with the CPU 11.

The accounting terminal 20 includes the above described touch panel-type display unit 21, card reader 22, printer 23, and drawer 27, and a CPU 24, a ROM 25, and a RAM 26 of a microcomputer.

The CPU 24 is connected to the CPU 11 of the controller 10 with a cable, for example. The ROM 25 stores a program which is necessary for controlling the CPU 24, an application program which is necessary for accounting, and character data or image data for generating various screens which are displayed on the touch panel-type display unit 21. The RAM 26 also stores various data items as needed.

In addition, the CPU 11 of the controller 10, and the CPU 24 of the accounting terminal 20 include units (1) to (3) for performing important functions based on the programs in the ROMs 14 and 25. Units (1) to (3) are described as follows:

(1) A selection unit which displays a selection screen on which images of one or more products are included on the touch panel-type display unit 2, and selects products on the same selection screen according to a touch operation with respect to the selection screen;

(2) A control unit which obtains a total amount of products which are selected by the selection unit, and displays the obtained total amount on the touch panel-type display unit 2; and

(3) An accounting control unit which settles the total amount which is obtained by the control unit in the accounting terminal 20.

In addition, the selection screen includes a product guide screen for displaying an image of a product along with product information relating to the product. The selection screen also includes a selected product screen for displaying an image of the product which is selected by the selection unit, or product information relating to the product. The selection screen also includes a salesperson operation screen which is subject to a touch operation by a salesperson in order for setting of operation modes, or the like.

Specifically, the control unit described in (2) obtains a total amount of products corresponding to images or product information in the selected product screen. The selected product screen includes a display of a confirmation key for confirming products corresponding to the images or the product information on the selected product screen as purchase targets.

When there is an operation with respect to the confirmation key, the accounting control unit described in (3) executes accounting of the total amount which is obtained by the control unit in the accounting terminal 20.

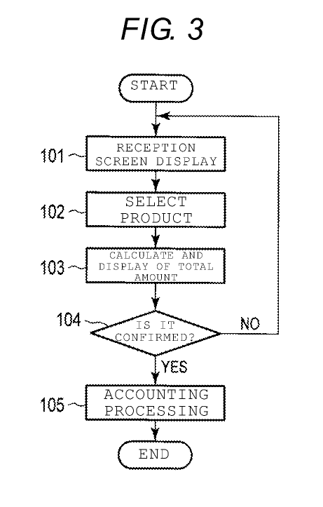

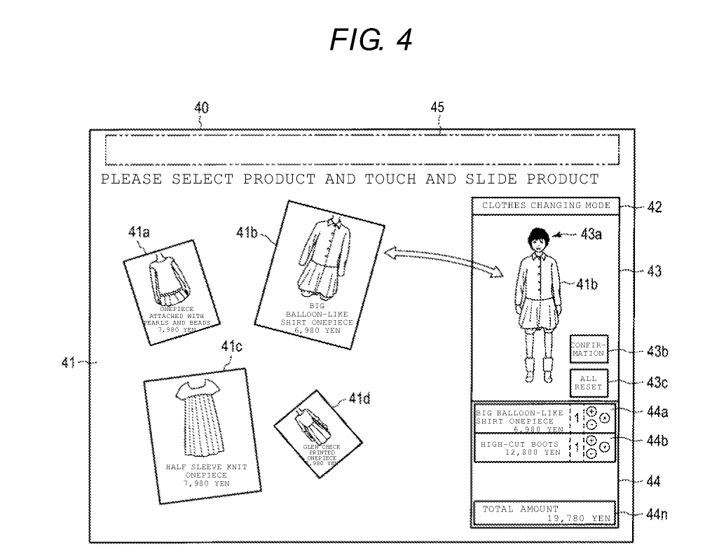

Controls which are executed by the CPUs 11 and 24 will be described with reference to a flowchart in FIG. 3. The CPU 11 of the controller 10 displays a selection screen 40 which is illustrated in FIG. 4 on the touch panel-type display unit 2 (step 101). In addition, the CPU 11 selects products on the same selection screen 40 according to a touch operation with respect to the selection screen 40 (step 102).

Subsequently, the CPU 11 obtains a total amount of the selected products, and displays thereof on the touch panel-type display unit (step 103).

When there is a touch operation with respect to a confirmation key 43b in the selection screen 40, which will be described later (step 104), the CPU 24 of the accounting terminal 20 performs accounting of the obtained total amount based on a card which is presented by a shopper, or cash (step 105).

Specified examples of the above controls will be described according to an actual operation of a shopper. First, the selection screen 40 includes a product guide screen 41 which displays an image of a product, along with product information relating to the product, in a size which spreads approximately in the entire region. In addition, the selection screen 40 includes a selected product screen 42 which displays an image of a product on the product guide screen 41 which is selected by an operation of a customer, and product information relating to the product on one side on the product guide screen 41. In addition, the selection screen 40 includes a salesperson operation screen 45 which is subject to a touch operation by a salesperson for setting of operation modes, or the like.

When a clothes changing mode is set by a touch operation of a salesperson with respect to the salesperson operation screen 45, the CPU 11 displays clothes images 41a, 41b, 41c, 41d, etc. on the product guide screen 41 along with announcing sentence such as “please select a product, and touch and slide thereof” based on the product image database in the hard disk drive 13. The clothes images 41a, 41b, 41c, 41d, etc. include character displays of a product name and price as respective pieces of product information.

A shopper touches a display region of a favorite clothes image among the clothes images 41a, 41b, 41c, 41d, etc. on the product guide screen 41 using a finger, and slides the touching finger to the selected product screen 42 while facing a salesperson by interposing the table 1 therebetween, and while listening to explanations of the salesperson as necessary. The touch and sliding operations of the clothes image 41b are denoted by a thick arrow in FIG. 4.

In a case of the clothes changing mode, the selected product screen 42 includes a clothes changing operation screen 43. In addition, the clothes changing operation screen 43 includes displays of a body image 43a, the confirmation key 43b, and an all reset key 43c.

The CPU 11 displays the clothes image 41b which is subject to the touch and sliding operations by compositing the clothes image 41b with the body image 43a. Along with the composited display, the CPU 11 removes the display of the clothes image 41b on the product guide screen 41. In addition, in this case, the CPU 11 may leave the display of the clothes image 41b as it is without removing.

The selected product screen 42 also includes a product information screen 44, in addition to the clothes changing operation screen 43. In addition, the product information screen 44 includes displays of product information display columns 44a, 44b, . . . corresponding to all of the clothes images which are displayed on the clothes changing operation screen 43, and a total amount display column 44n.

The CPU 11 displays product information of clothes corresponding to the clothes image 41b (big balloon-like shirt-dress; 6,980 yen), the purchase number of the clothes, for example, “1”, a plus (+) key and a minus (−) key for setting increase and decrease of the purchase number using a touch operation, and a cancelling key (x) for cancelling the clothes using a touch operation in the product information display column 44a.

Along with the display, the CPU 11 adds up product prices in all of pieces of product information which are displayed in the product information display columns 44a, 44b, etc., and displays the total amount in the total amount display column 44n.

A shopper is able to determine whether or not to purchase clothes corresponding to the clothes image 41b by viewing the composite image of the body image 43a and the clothes image 41b.

The shopper is also able to perform a composite display of any one of different clothes images 41a, 41c, 41d, etc., by further overlapping thereof, by repeating touch and sliding operations in the same manner as described above.

When the shopper does not like the clothes image 41b, the shopper performs a touch operation on the display of the clothes image 41b on the clothes changing operation screen 43, and slides the touch operation as it is to the product guide screen 41.

At the time of this operation, the CPU 11 removes the display of the clothes image 41b on the clothes changing operation screen 43, and the display of the clothes image 41b is restored on the product guide screen 41. In addition, the CPU 11 removes the display of the clothes image 41b on the clothes changing operation screen 43, and also removes the display of the product information display column 44a on the product information screen 44 at the same time.

When the shopper does not like the clothes image 41b in the middle of a composition display, the shopper may perform a touch operation on the cancelling key (x) in the product information display column 44a, instead of the touch and sliding operations with respect to the display of the clothes image 41b. Alternatively, the shopper may perform a touch operation of a display of the all reset key 43c on the clothes changing operation screen 43.

When the display of the all reset key 43c is subject to a touch operation, the CPU 11 removes displays of all of the clothes images which are overlapped with the body image 43a thereon, and restores the displays of all of the clothes images on the product guide screen 41.

When the shopper likes one, or the plurality of clothes images which are composited and overlapped with the body image 43a, and wants to purchase the clothes, the shopper performs a touch operation of a display of the confirmation key 43b on the clothes changing operation screen 43. When the display of the confirmation key 43b is subject to the touch operation, the CPU 11 commands the CPU 24 of the accounting terminal 20 to execute accounting.

The CPU 24 of the accounting terminal 20 executes accounting of products corresponding to all of pieces of product information which are displayed in the product information display columns 44a, 44b, . . . according to the command from the CPU 11.

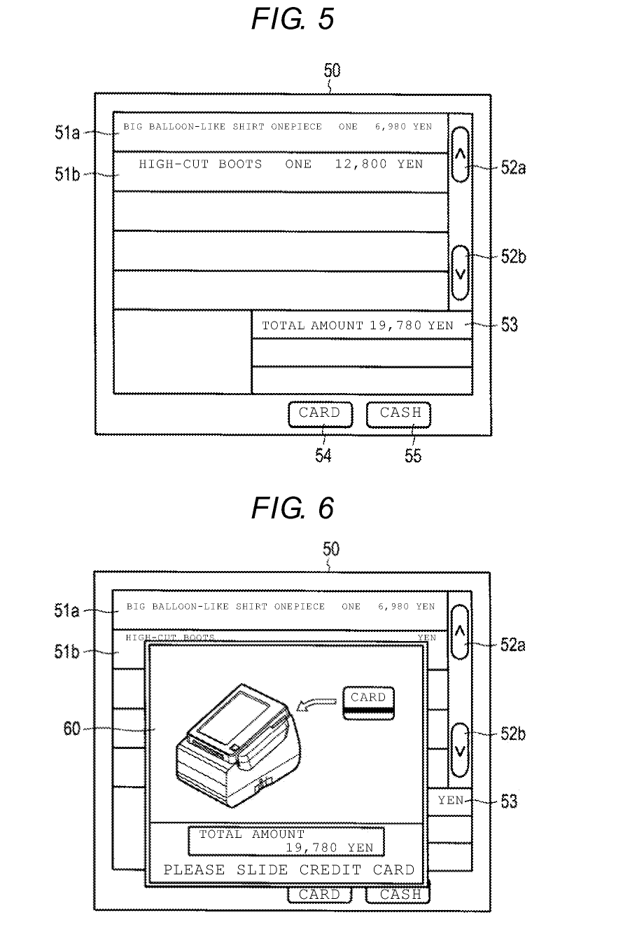

When executing the accounting, the CPU 24 displays an accounting screen 50 which is illustrated in FIG. 5 on the touch panel-type display unit 21 of the accounting terminal 20.

The accounting screen 50 includes displays of product information display columns 51a, 51b, etc., with the same contents as those of the product information display columns 44a, 44b, etc. The accounting screen 50 also includes displays of sliding display keys 52a and 52b which perform sliding displays of the product information display columns 51a, 51b, etc. in the vertical direction. The accounting screen 50 also includes displays of a total amount display column 53 with the same contents as those of the total amount display column 44n, a card settlement key 54 which designates a card settlement, a cash settlement key 55 which designates a cash settlement, or the like.

When the shopper wants a card settlement, the salesperson performs a touch operation on the display of the card settlement key 54. The CPU 24 performs a pop-up display of a guide screen 60 which is illustrated in FIG. 6 on the accounting screen 50. The guide screen 60 is a screen which guides the salesperson to insert a card which is possessed by the shopper into the card reader 22 of the accounting terminal 20, and to perform a sliding operation.

The CPU 24 of the accounting terminal 20 completes the card settlement based on readout information from the card reader 22, and further, as necessary, based on identification information such as a personal identification number which is input by a touch operation on the touch panel-type display unit 21.

The CPU 11 of the controller 10 displays the contents of the selected product screen 42 by turning thereof by 180 degrees so as to face the salesperson side as a purchased product list of a shopper, along with completion of accounting of the CPU 24. The salesperson brings out products which are included in the purchased product list from a showcase or a warehouse in the store, and hands the products to the shopper. It is also possible to deliver the product to the home of the shopper by bringing out the products later.

A shopper is able to select favorite products while getting advice of a salesperson, and while enjoying images of products by performing clothes changing displaying on the touch panel-type display unit 2. In addition, the shopper is able to perform a card settlement of selected products on the spot. Since the salesperson does not take the card of the shopper to another place, it is reliable for the shopper, and reliability of the store is improved.

It is possible for a salesperson to sell a product while having communication with a shopper through a display of the touch panel-type display unit 2, and while giving specialized advice in some cases. It is also possible to teach a shopper who does not know how to operate the touch panel-type display unit 2 an appropriate operation on the spot.

In addition, according to the embodiment, the touch panel-type display unit 2 which is arranged on the table 1 is used as a display unit, however, for example, it is also possible to use the touch panel-type display unit 2 as a display unit arranged on a floor mounted display board which is used in a presentation of a product explanation, a meeting, or the like.

According to the embodiment, a clothes changing mode relating to clothes is exemplified. The disclosed system is also applicable to other types of retail stores. For example, in a case of a store which sells cars, it is also possible to set a mode in which a salesperson sells a car, and optional components thereof while having communication with a visitor to the store by the table 1 being interposed therebetween. The visitor of the store is able to select a favorite car while appropriately compositing images of optional components of a car, or an image of color of a car body on a car body image display of the touch panel-type display unit 2.

Another example is a store which sells travel products. With the disclosed system, it is possible to set a mode in which a salesperson performs planning and suggestions for a trip, and selling of optional tours, or the like, while having communication with a visitor to the store by the table 1 being interposed therebetween. The visitor to the store is able to select a favorite trip while appropriately combining an image of a place the visitor wants to visit, or an image of a hotel on a photographic image display of the touch panel-type display unit 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales system comprising:
a display unit arranged at a retail point-of-sale location;
a selection unit configured to provide for display on the display unit a selection screen including at least one product image, and accept a user selection of one or more product images displayed in the selection screen;
a control unit configured to calculate and provide for display on the display unit a total purchase price of products corresponding to the selected product images; and
an accounting unit configured to settle payment for the total purchase price of the products.

2. The sales system according to claim 1, wherein the display unit is a touch panel-type display unit arranged on a sales counter, and the accounting unit is a terminal for accepting a card payment that is also arranged on the sales counter.

3. The sales system according to claim 1, wherein the display unit is a touch panel-type display unit arranged on a display board, and the accounting unit is a terminal for accepting a card payment that is also arranged on the display board.

4. The sales system according to claim 1, wherein the selection screen includes a product guide screen with a product image and product information corresponding to the product image, and a selected product screen which includes product images which are selected in the selection unit.

5. The sales system according to claim 4, wherein the selected product screen further includes product information corresponding to the product images which are selected in the selection unit.

6. The sales system according to claim 5, wherein the selected product screen includes a confirmation key for confirming a product corresponding to a product image or product information on the selected product screen as a purchase target.

7. The sales system according to claim 6, wherein the accounting unit settles payment for the total purchase price when there is an operation with respect to the confirmation key.

8. A sales method comprising:
displaying on a display unit at a point-of-sale location a selection screen including at least one product image;
accepting a user selection of one or more product images displayed in the selection screen;
calculating and providing for display on the display unit a total purchase price of products corresponding to the selected product images; and
settling payment for the total purchase price of the products.

9. The sales method according to claim 8, wherein the display unit is a touch panel-type display unit arranged on a sales counter, and the accounting unit is a terminal for accepting a card payment that is also arranged on the sales counter.

10. The sales method according to claim 8, wherein the display unit is a touch panel-type display unit arranged on a display board, and the accounting unit is a terminal for accepting a card payment that is also arranged on the display board.

11. The sales method according to claim 8, wherein the selection screen includes a product guide screen with a product image and product information corresponding to the product image, and a selected product screen which includes product images which are selected in the selection unit.

12. The sales method according to claim 11, wherein the selected product screen further includes product information corresponding to the product images which are selected in the selection unit.

13. The sales method according to claim 12, further comprising:
accepting confirmation of a product corresponding to a product image or product information on the selected product screen as a purchase target.

14. The sales method according to claim 12, wherein said settling includes:
accepting payment for the total purchase price when the confirmation is accepted.

15. A non-transitory computer readable medium containing software for use in a sales system, the software causing the sales system to perform the following steps of:
displaying on a display unit at a point-of-sale location a selection screen including at least one product image;
accepting a user selection of one or more product images displayed in the selection screen;
calculating and providing for display on the display unit a total purchase price of products corresponding to the selected product images; and
settling payment for the total purchase price of the products.

16. The computer readable medium according to claim 15, wherein said settling includes accepting a card payment at a terminal arranged on a sales counter table.

17. The computer readable medium according to claim 15, wherein the selection screen includes a product guide screen with a product image and product information corresponding to the product image, and a selected product screen which includes product images which are selected in the selection unit.

18. The computer readable medium according to claim 17, wherein the selected product screen further includes product information corresponding to the product images which are selected in the selection unit.

19. The computer readable medium according to claim 15, wherein the software further causes the computer to perform the following additional step of:
accepting confirmation of a product corresponding to a product image or product information on the selected product screen as a purchase target.

20. The computer readable medium according to claim 15, wherein said settling includes accepting payment for the total purchase price when confirmation is accepted.
